(19) United States
(12) Patent Application Publication
(10) Pub. No.: US 2021/0309487 A1
(43) Pub. Date: Oct. 7, 2021

(54) SAFETY SYSTEM, ELEVATOR, AND METHOD FOR UPGRADING A SAFETY SYSTEM OF AN ELEVATOR

(71) Applicant: Kone Corporation, Helsinki (FI)

(72) Inventors: Tuukka KAUPPINEN, Helsinki (FI); Henri WENLIN, Helsinki (FI); Mikko PAAKKINEN, Helsinki (FI)

(73) Assignee: Kone Corporation, Helsinki (FI)

(21) Appl. No.: 17/218,851

(22) Filed: Mar. 31, 2021

(30) Foreign Application Priority Data
Apr. 7, 2020 (EP) 20168465.1

(51) Int. Cl. B66B 5/00; B66B 1/34; B66B 5/04; B66B 5/02; B66B 19/00

(52) U.S. Cl. CPC B66B 5/0031; B66B 1/3461; G01D 5/20; B66B 5/02; B66B 19/007; B66B 5/04

(57) ABSTRACT

A safety system of an elevator provided herein may comprise a safety controller, a sensor unit configured to generate a first sensor signal indicating a travelling parameter and to provide the first sensor signal to an elevator drive unit of the elevator, and a signal converter connected to the sensor unit and configured to convert the first sensor signal into a second signal in a second format compatible with the safety controller and to provide the second signal in the second format to the safety controller. The safety controller may be configured to receive the second signal in the second format and to determine, based on the second signal, if there is an emergency condition.

### RELATED APPLICATIONS

This application claims priority to European Patent Application No. 20168465.1 filed on Apr. 7, 2020, the entire contents of which are incorporated herein by reference.

### FIELD OF THE INVENTION

The present invention relates in general to elevators. In particular, however not exclusively, the present invention concerns a safety system of an elevator, such as configured to be capable of determining an emergency condition of an elevator and preferably further initiating an emergency stop of the elevator.

### BACKGROUND

Traditionally, elevator drives have many separate sensors and actuators which are general-purpose devices meaning that they are not designed for any specific elevator drive application. Often, they are complicated, expensive, and slow because of many overlapping processing and control functions. Consequently, a separate sensor is needed for each application. The same is true for elevator safety systems.

### SUMMARY

An objective of the present invention is to provide a safety system, an elevator, and a method for upgrading a safety system of an elevator. Another objective of the present invention is that the safety system, the elevator, and the method facilitates the operation of the safety system without increasing the amount of sensors for measuring travelling parameters of the elevator, such as related to the operation of the motor and/or traction sheave of the elevator.

The objectives of the invention are reached by a safety system, an elevator, and a method as defined by the respective independent claims.

According to a first aspect, a safety system of an elevator. The safety system comprises a safety controller, a sensor unit configured to generate a first sensor signal indicating a travelling parameter and to provide the first sensor signal to an elevator drive unit of the elevator, and a signal converter connected to the sensor unit and configured to convert the first sensor signal into a second signal in a second format compatible with the safety controller and to provide the secand signal in the second format to the safety controller. Further, the safety controller is configured to receive the second signal in the second format and to determine, based on the second signal, if there is an emergency condition.

The travelling parameter of the elevator refers herein to a parameter which is indirectly related to the movement of an elevator car of the elevator. Thus, the travelling parameter may refer to a parameter of the operation of the motor or the traction sheave of the elevator. The travelling parameter may include, for example, at least one of the following: a rotor angle position, a rotating velocity, having a speed and/or a direction, a rotating amount of a traction sheave, an acceleration and/or a deceleration of a traction sheave.

In various embodiments, the change of format performed by the signal converter means more than merely filtering and/or changing resolution of the first sensor signal. The format change may mean, for example, changing the signal from an analog signal into a digital signal. In various embodiments, the format change may mean actually converting the first sensor signal to be suitable for utilizing in the safety controller and, optionally, some other devices of the elevator.

In various embodiments, the safety controller may be configured to cause an emergency stop in case of the determination of the emergency condition. For example, the safety controller may be an emergency terminal speed limit controller (ETSL).

In an embodiment, the safety controller may be configured to compare the travelling parameter carried by the second signal with an emergency stopping criteria, such as related to the speed of the motor, for determining the emergency condition.

In various embodiments, the sensor unit may comprise an encoder. The encoder may optionally utilize digital, synchronous serial communication technology.

In some embodiments, the encoder may be a Synchronous Serial Interface (SSI) encoder. Preferably, the first sensor signal may be in SSI signal format.

In some embodiments, the sensor unit may comprise a magnetic field sensor. Alternatively or in addition, the sensor unit may comprise an inductive proximity sensor.

In various embodiments, the first sensor signal may be an analog signal.

In various embodiments, the second signal with the second format is a quadrature signal.

In some embodiments, the second signal with the second format may be in a data frame format, such as one of the following: an ethernet frame, a Controller Area Network (CAN) bus frame, or a Local Operating Network (LON) bus frame.

In various embodiments, the signal converter may be arranged to or in a close connection with the elevator drive unit.

According to a second aspect, an elevator is provided. The elevator comprises an elevator car arranged to be moved in an elevator shaft by a motor of the elevator, and an elevator drive unit arranged to operate the motor. Furthermore, the elevator comprises the safety system according to the first aspect.

According to a third aspect, a method for upgrading a safety system of an elevator is provided. The safety system comprises, that is prior to the implementation of the method, a present sensor unit arranged in connection with a motor of the elevator and configured to generate a second signal with a second format indicating a travelling parameter and to provide the second signal to an elevator drive unit operating the motor, and a safety controller configured to receive the second signal and to determine, based on the second signal, if there is an emergency condition.

The method comprises replacing the present sensor unit with a sensor unit, wherein the sensor unit is configured to generate a first sensor signal with a first format being different than the second format. The sensor unit is configured to provide the first sensor signal to the elevator drive unit. The method further comprises obtaining or manufacturing a signal converter configured to convert the first sensor signal with the first format into the second signal with the second format, and arranging the signal converter in connection with the sensor unit and to provide the second signal in the second format to the safety controller.

In various embodiments, the arranging may comprise arranging the signal converter to or in a close connection with the elevator drive unit.

The present invention provides a safety system, an elevator, and a method for upgrading a safety system of an elevator. The present invention provides advantages over known solutions in that the number of sensors may be reduced with respect to measuring parameters of the operation of the motor and/or the traction sheave of the elevator with respect to obtaining necessary information for the safety system of the elevator.

Various other advantages will become clear to a skilled person based on the following detailed description.

The expression “a plurality of” may refer to any positive integer starting from two (2), that is being at least two.

The terms “first”, “second” and “third” are herein used to distinguish one element from other element, and not to specially prioritize or order them, if not otherwise explicitly stated.

The exemplary embodiments of the present invention presented herein are not to be interpreted to pose limitations to the applicability of the appended claims. The verb “to comprise” is used herein as an open limitation that does not exclude the existence of also unrecited features. The features recited in depending claims are mutually freely combinable unless otherwise explicitly stated.

The novel features which are considered as characteristic of the present invention are set forth in particular in the appended claims. The present invention itself, however, both as to its construction and its method of operation, together with additional objectives and advantages thereof, will be best understood from the following description of specific embodiments when read in connection with the accompanying drawings.

### BRIEF DESCRIPTION OF FIGURES

Some embodiments of the invention are illustrated by way of example, and not by way of limitation, in the figures of the accompanying drawings.

FIG. 1 illustrates schematically an elevator according to an embodiment of the present invention.

FIGS. 2A and 2B illustrate schematically safety systems according to some embodiments of the present invention.

FIG. 3 shows a flow diagram of a method in accordance with an embodiment of the present invention.

### DETAILED DESCRIPTION OF SOME EMBODIMENTS

According to various embodiments of the invention, an elevator safety system may be provided. In particular, the safety system may be an emergency stopping system of an elevator. With this safety system, the number of sensors measuring travelling parameters of an elevator can be reduced without measurement data shortage. Many traditional complicated and expensive components, such as pulse encoders, may be omitted, for instance. In various embodiments, the travelling parameter of the elevator may include at least one of the following: a rotor angle position, a rotating velocity, having a speed and/or a direction, a rotating amount of a traction sheave, an acceleration and/or a deceleration of a traction sheave.

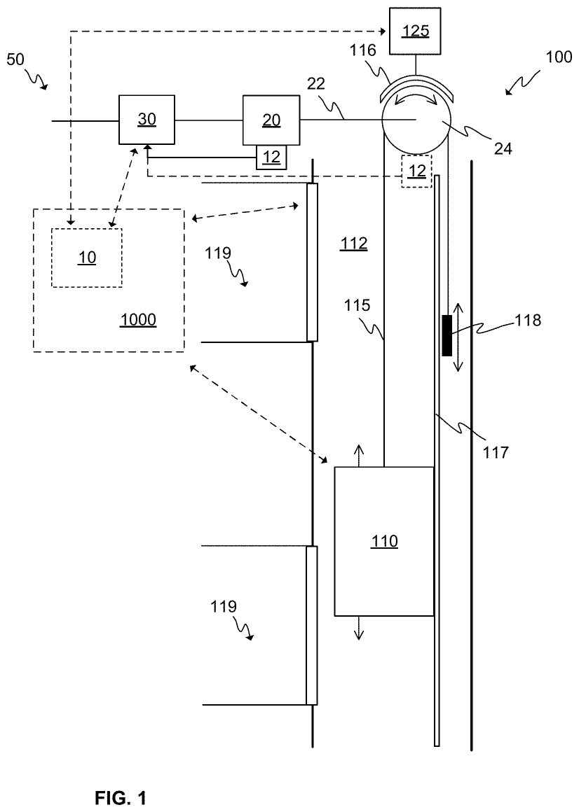

FIG. 1 illustrates schematically an elevator according to an embodiment of the present invention. The elevator 100 may comprise an elevator car 110 arranged to be moved in an elevator shaft 112. The moving of the elevator car 110 may be implemented, preferably, by a hoisting rope or belt 115 in connection with a traction sheave 24 or the like. Furthermore, the elevator 100 may comprise a motor 20 arranged to operate, such as rotate, the traction sheave 24 for moving the elevator car 110. The traction sheave 24 may be connected, via a mechanical connection 22, directly or indirectly via a gear to a shaft of the motor 20. The elevator 100 may comprise a machine room or be machine roomless, such as have the motor 20 in the elevator shaft 112.

The elevator 100 may preferably comprise at least one hoisting machinery brake 116 configured for resisting or, preferably, preventing the movement of the motor 20, that is the rotor thereof, directly or via the traction sheave 114 or components thereof and/or therebetween when such an action is needed. Especially, the movement may be prevented in an emergency condition of the elevator 100. Furthermore, the elevator 100 may comprise a brake controller 125 configured to operate at least one of the at least one hoisting machinery brake 116. The brake controller 125 may further be in connection with other elements of the elevator 100, such as an elevator control unit 1000. The brake controller 125 may comprise an actuator (not shown) for operating the brake 116 or at least be in connection with such an actuating device.

In accordance with various embodiments, and as shown in FIG. 1, a safety system 50 of an elevator 100 is presented. The safety system 50 may comprise at least a safety controller 10 and a sensor unit 12 configured to generate a first sensor signal, for example, in a first format, including information about at least one travelling parameter. The sensor unit 12 may be adapted for generating the first sensor signal such as to be provided to an elevator drive unit 30 for operating and controlling the operation of the motor 20. The safety system 50 preferably further comprises a signal converter (not shown in FIG. 1) connected to the sensor unit 12 and configured to convert the first sensor signal into a second signal having a second format compatible with the safety controller 10. Still further, the safety controller 10 may be configured to receive the second signal in the second format and to determine, based on the second signal, if the conditions are fulfilled to determine an emergency condition of the elevator 100. The second format of the second signal is, preferably, different than the first format of the first sensor signal.

The elevator control unit 1000 may be configured to control the operation of the elevator 100 in general. This may mean a variety of things as is known to a skilled person in the art of elevators. The elevator control unit 1000 may be in connection with safety elements and devices, such as a safety chain, of the elevator 100. The elevator control unit may be configured to control the movement of the elevator car 110 in the elevator shaft 112, such as via an elevator drive unit 30.

In various embodiments, the elevator control unit 1000 may comprise or be at least arranged in connection with the safety controller 10.

There may additionally be, at least in some embodiments, a counterweight 118 arranged in connection with the elevator car 110 such as is known to a person skilled in the art of elevators. Still further, the elevator 100 may additionally comprise a guide rail 117 or rails 117 arranged into the elevator shaft 112 for guiding the movement of the elevator car 110.

The elevator 100 of FIG. 1 further illustrates schematically an elevator drive unit 30, such as including an inverter or a frequency converter, for connecting to, and controlling, by a controller thereof, the operation of, the motor 20. The controller may preferably be configured to operate the elevator drive unit 30 to provide electrical power (signals), such as having variable voltage and/or current, and variable frequency, to the motor 20. The controller may be a separate controller device or be comprised in the elevator drive unit 30, for instance.

In addition, the elevator 100 may comprise a sensor unit 12 arranged in connection with the motor 20 and/or the traction sheave 24 for determining at least one travelling parameter of the elevator 100, preferably an angle position and/or a rotating speed, and/or an acceleration and/or a deceleration of the motor 20, that is the rotor thereof, or the traction sheave 24. The sensor unit 12 is preferably connected to the elevator drive unit 30 for providing a first signal thereto, the first signal being produced by the sensor unit 12 and including information related to the at least one travelling parameter. The first signal may include information about at least one of the following: a rotor angle position, a rotating velocity, having a speed and/or a direction, a rotating amount of a traction sheave, an acceleration and/or a deceleration of a traction sheave; that is of at least one travelling parameter of the elevator 100.

Still further, the elevator drive unit 30 may be arranged to be fed by an electrical power source, such as of the elevator 100, for example from an external electrical power grid having a fundamental frequency of 50 or 60 Hz, or from another power source, for example, a battery system. Additionally, the electrical power source may intake electrical power from the elevator drive unit 30.

The elevator 100 preferably comprises landing floors 19 and, for example, landing floor doors and/or openings, between which the elevator car 10 is arranged to be moved during normal operation of the elevator 100, such as to move persons and/or items between said floors 19.

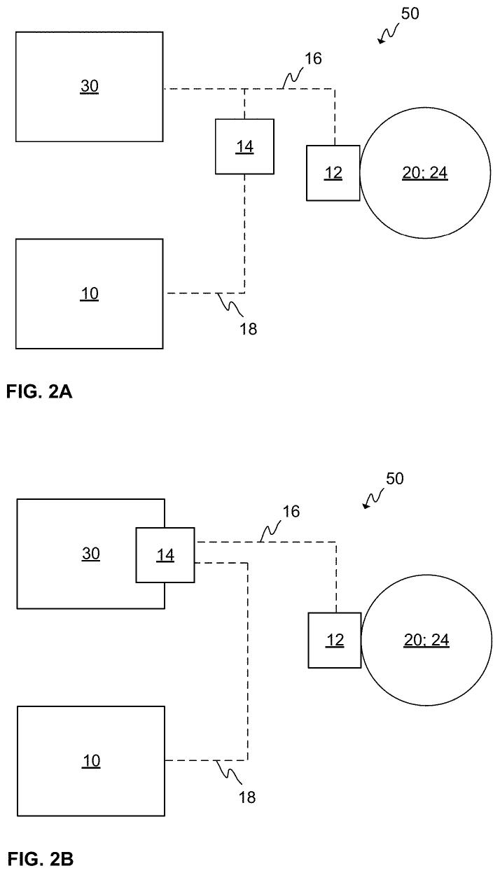

FIGS. 2A and 2B illustrate schematically safety systems 50 according to some embodiments of the present invention. FIG. 2A illustrates the safety controller 10 and the sensor unit 12 which may be configured to generate a first sensor signal indicating a travelling parameter and to provide the first sensor signal to an elevator drive unit 30 of the elevator. The signal converter 14 is further shown.

The signal converter 14 may be connected to the sensor unit 12 and configured to convert the first sensor signal into a second signal in a second format compatible with the safety controller 10. The second format of the second signal is, preferably, different than the format of the first sensor signal. The signal converter 14 may be further configured to provide the second signal in the second format to the safety controller 10. The safety controller 10 may be configured to receive and read the second signal in the second format and to determine, based on the second signal, if there is an emergency condition in the elevator 100. As also seen in FIG. 2A, the signal converter 14 may be arranged essentially anywhere in the elevator 100 as long as the first sensor signal is arranged to be provided at least to the signal converter 14.

The signal converter 14 may be implemented by utilizing a circuitry comprising a plurality of electronic components and/or with a programmable logic circuit or programmable processing unit.

FIG. 2B illustrates an embodiment of the safety system 50 which is otherwise similar to the one shown in FIG. 2A except that the signal converter 14 is comprised in the elevator drive unit 30 or at least in a close connection thereto, such as in the same rack for mounting multiple electronic equipment.

In some embodiments, for example related to ones in FIGS. 2A and 2B, the first sensor signal may be transmitted, preferably essentially unmodified, through the signal converter 14 to the elevator drive unit 30. Alternatively, the first sensor signal may be directly provided to the elevator drive unit 30.

As can be seen in FIGS. 2A and 2B, the signal converter 14 may be connected via the first communication channel 16 to the sensor unit 14 and via the second communication channel 18 to the safety controller 10 and, optionally, to some other systems of the elevator 100. In various embodiments, the other systems may refer to system monitoring the speed of the elevator car 110 and/or the speed of the elevator car 110, or the motor or the traction sheave when the elevator car 110, is close to the ends of the elevator shaft 112.

According to various embodiments, the sensor unit 12 may comprise an encoder for producing the first sensor signal, preferably, including information about at least one travelling parameter.

The sensor unit 12 may comprise a magnetic field sensor. Alternatively, the sensor unit 12 may comprise an inductive proximity sensor.

In various embodiments, such as related to the ones in FIGS. 2A and 2B, the first sensor signal may be arranged to be transmitted via a first communication channel 16 arranged between the sensor unit 12 and the elevator drive unit 30. Optionally, the first sensor signal is an analog signal. Additionally, the second signal may be arranged to be transmitted via a second communication channel 18. Optionally, the format of the second signal is a quadrature encoder signal. The first communication channel 16 and the second communication channel 18 may be identical or similar types of channels or, alternatively preferably, different types of channels with respect to each other.

The first communication channel 16 may be adapted, for example, for utilizing with one of the following sensor technologies, that is to transmit the first signal therefrom: a direct current (DC) tachometer, a resolver, a pulse encoder, such as a rotary encoder, a Sin/Cos encoder. Alternatively, the first communication channel 16 may be adapted, for example, for utilizing with one of the following sensor technologies, that is to transmit the first signal therefrom, utilizing serial communication: a Synchronous Serial Interface (SSI) encoder, a bidirectional/serial/synchronous (BiSS) encoder, an Encoder Data (EnDat) encoder.

The second communication channel 16 may be adapted, for example, for utilizing with a data frame format, such as one of the following: an ethernet frame, a Controller Area Network (CAN) bus frame, or a Local Operating Network (LON) bus frame.

In an embodiment, the encoder of the sensor unit 12 may be an SSI encoder. Therefore, in this embodiment, the first sensor signal is of the format, that is the first format, which is suitable for such a synchronous serial communication being in the SSI signal format. The signal converter 14 may, optionally, be configured to convert the first format of such synchronous serial communication into a quadrature pulse wave based on the first sensor signal and including information about the travelling parameter indicated by the first sensor signal.

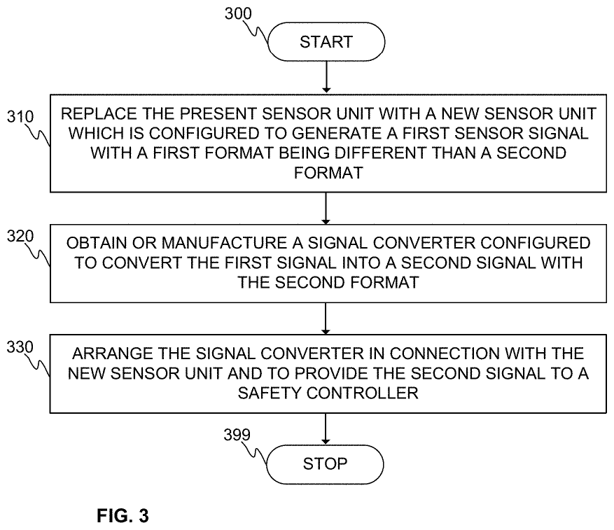

FIG. 3 shows a flow diagram of a method in accordance with an embodiment of the present invention.

Step 300 refers to a start-up phase of the method. This may in some cases mean shutting down the elevator 100 in order to upgrade the elevator 100 or particularly the safety system 50 thereof.

Step 310 refers to replacing the present or current sensor unit with a sensor unit 12, that is a new sensor unit 12. The sensor unit 12 may be configured to generate a first sensor signal with a first format being different than the second format of the second signal. The sensor unit 12 may further be configured to provide the first sensor signal to the elevator drive unit 30.

Step 320 refers to obtaining or manufacturing a signal converter 14 configured to convert the first sensor signal with the first format into the second signal with the second format.

Step 330 refers to arranging the signal converter 14 in connection with the sensor unit 12 and to provide the second signal in the second format to the safety controller 10. In some embodiments, the arranging may comprise arranging the signal converter 14 to or in a close connection with the elevator drive unit 30.

Method execution may be stopped at step 399. The safety system 50 has been upgraded with the new sensor unit 12.

Advantage of the method is that even though the sensor unit 12 is being replaced there is no need to change the safety controller 14 and, optionally, also the other systems utilizing the measurement data of the sensor unit 12. Furthermore, there is no need to install new sensors for the safety controller 14 and, optionally, also the other systems utilizing the measurement data of the sensor unit 12.

1. A safety system of an elevator, comprising:
a safety controller;
a sensor unit configured to generate a first sensor signal indicating a travelling parameter and to provide the first sensor signal to an elevator drive unit of the elevator; wherein the safety system comprises
a signal converter connected to the sensor unit and configured to convert the first sensor signal into a second signal in a second format compatible with the safety controller and to provide the second signal in the second format to the safety controller,
wherein the safety controller is configured to receive the second signal in the second format and to determine, based on the second signal, if there is an emergency condition.

2. The safety system according to claim 1, wherein safety controller is configured to compare the travelling parameter carried by the second signal with an emergency stopping criteria for determining the emergency condition.

3. The safety system according to claim 1, wherein safety controller is configured to cause an emergency stop in case of the determination of the emergency condition.

4. The safety system according to claim 1, wherein the safety controller is an emergency terminal speed limit controller.

5. The safety system according to claim 1, wherein an encoder of the sensor unit is a Synchronous Serial Interface encoder.

6. The safety system according to claim 1, wherein the sensor unit comprises a magnetic field sensor.

7. The safety system according to claim 1, wherein the sensor unit comprises an inductive proximity sensor.

8. The safety system according to claim 1, wherein the first sensor signal is in Synchronous Serial Interface signal format.

9. The safety system according to claim 1, wherein the first sensor signal is an analog signal.

10. The safety system according to claim 1, wherein the second signal with the second format is a quadrature signal.

11. The safety system according to claim 1, wherein the second signal with the second format is in a data frame format, such as one of the following: an ethernet frame, a Controller Area Network bus frame, or a Local Operating Network bus frame.

12. The safety system according to claim 1, wherein the signal converter is arranged to or in a close connection with the elevator drive unit.

13. An elevator comprising an elevator car arranged to be moved in an elevator shaft by a motor of the elevator, and an elevator drive unit arranged to operate the motor, wherein the elevator comprises the safety system according to claim 1.

14. A method for upgrading a safety system of an elevator, wherein the safety system comprises a present sensor unit arranged in connection with a motor of the elevator and configured to generate a second signal with a second format indicating a travelling parameter and to provide the second signal to an elevator drive unit operating the motor, and a safety controller configured to receive the second signal and to determine, based on the second signal, if there is an emergency condition, wherein the method comprises:
replacing the present sensor unit with a sensor unit, wherein the sensor unit is configured to generate a first sensor signal with a first format being different than the second format, configured to provide the first sensor signal to the elevator drive unit,
wherein the method further comprises:
obtaining or manufacturing a signal converter configured to convert the first sensor signal with the first format into the second signal with the second format, and
arranging the signal converter in connection with the sensor unit and to provide the second signal in the second format to the safety controller.

15. The method of claim 14, wherein the arranging comprises arranging the signal converter to or in a close connection with the elevator drive unit.
